(19) United States
(12) Patent Application Publication
(10) Pub. No.: US 2018/0182044 A1
(43) Pub. Date: Jun. 28, 2018

(54) SYSTEMS AND METHODS FOR GENERATING A USER PROFILE USING DATA ASSOCIATED WITH CASH-BASED FINANCIAL TRANSACTIONS

(71) Applicant: MasterCard International Incorporated, Purchase, NY (US)

(72) Inventors: Marianne Iannace, North Salem, NY (US); Margaret A. Shine, Stamford, CT (US)

(21) Appl. No.: 15/391,175

(22) Filed: Dec. 27, 2016

(51) Int. Cl. G06Q 40/00; G06Q 30/02

(52) U.S. Cl. CPC G06Q 40/12; G06Q 30/0205

(57) ABSTRACT

Embodiments of the disclosure enable a system to generate transaction data associated with one or more financial transactions. The system analyzes location data associated with a first user account to determine a user footprint, analyzes first transaction data associated with the first user account to identify one or more first members associated with the user footprint, identifies one or more second members associated with the user footprint to generate a merchant list, analyzes second transaction data associated with one or more second user accounts to generate one or more parameters associated with the merchant list, and uses the parameters to generate third transaction data for use in generating a user profile associated with the first user account. Aspects of the disclosure provide for generating and/or modifying a user profile based on one or more cash-based financial transactions in an efficient and user-friendly manner.

### FIELD OF THE DISCLOSURE

The subject matter described herein relates generally to information processing and, more specifically, to systems and methods for generating one or more user profiles using transaction data associated with one or more cash-based financial transactions.

### BACKGROUND

Financial transaction cards have made great gains as a means to attract financial accounts to financial institutions and, in the case of credit cards, as a medium to create small loans and generate interest income for financial institutions. At least some financial institutions maintain user profiles to provide customized goods and/or services to its cardholders. User profiles may be generated, for example, using transaction data associated with one or more financial transactions. Transaction data generated by at least some known systems, however, is limited to financial transactions entered into using financial transaction cards and, thus, may not be representative of the cardholders' interests, preferences, and/or tendencies if, for example, the cardholders use other payment mechanisms and/or do not consistently use the financial transaction cards.

### SUMMARY

Embodiments of the disclosure enable a computing system to generate transaction data associated with one or more financial transactions. The computing system includes a memory device storing data associated with a plurality of user accounts and computer-executable instructions, and a processor. The processor executes the computer-executable instructions to analyze location data of a user device that is associated with a first user account to determine a user footprint, and analyze first transaction data associated with the first user account to identify one or more first members associated with the user footprint. The first transaction data is associated with one or more first financial transactions between the first members and a first user associated with the first user account. One or more second members associated with the user footprint that are different from the first members are identified to generate a member list. Second transaction data associated with one or more second user accounts is analyzed to generate one or more parameters associated with the member list. The second transaction data is associated with one or more second financial transactions between the second members and one or more second users associated with the second user accounts. The parameters are used to generate third transaction data for use in generating a user profile associated with the first user account. The third transaction data is associated with one or more third financial transactions between the second members and the first user.

In another aspect, one or more computer storage media embodied with computer-executable instructions are provided. The computer storage media includes a location component, a list component, and a projection component. Upon execution by at least one processor, the location component causes a computing system associated with the processor to obtain location data associated with a user device of a first user, and determine a user footprint based on the location data. The list component causes the computing system to identify a plurality of merchants associated with the user footprint, obtain first transaction data associated with one or more first financial transactions between one or more first merchants and the first user, identify one or more second merchants different from the first merchants, and generate a merchant list based on the second merchants. The projection component causes the computing system to obtain second transaction data associated with one or more second financial transactions between the second merchants and one or more second users different from the first user, generate one or more parameters associated with the merchant list based on the second transaction data, and generate third transaction data associated with one or more third financial transactions between the second merchants and the first user based on the one or more parameters for use in generating a user profile of the first user.

In yet another aspect, a computer-implemented method is provided for generating transaction data associated with one or more financial transactions. The computer-implemented method includes analyzing location data associated with a user device of a first user to determine a user footprint, analyzing first transaction data associated with the first user to identify one or more first merchants associated with the user footprint, identifying one or more second merchants associated with the user footprint that are different from the first merchants to generate a merchant list, analyzing second transaction data associated with one or more second users different from the first user to generate one or more parameters associated with the merchant list, and using the one or more parameters to generate third transaction data associated with one or more cash-based financial transactions between the one or more second merchants and the first user for use in generating a user profile associated with the first user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram illustrating an example environment for processing card-based financial transactions.

FIG. 2 is a block diagram illustrating an example environment for processing cash-based financial transactions.

FIG. 3 is a block diagram illustrating an example ecosystem for generating transaction data in an environment, such as the environment shown in FIG. 1 or FIG. 2.

FIG. 4 is a block diagram illustrating a user footprint that is representative of an area traversed by a user within a time period.

FIG. 5 is a block diagram illustrating a plurality of example components that may be used to generate transaction data in an environment, such as the environment shown in FIG. 1 or FIG. 2.

FIG. 6 is a flowchart of an example method for generating transaction data using a computing system, such as a computing system including the components shown in FIG. 5.

FIG. 7 is a block diagram illustrating an example operating environment in which transaction data may be generated.

Corresponding reference characters indicate corresponding parts throughout the drawings.

### DETAILED DESCRIPTION

The subject matter described herein relates to generating transaction data associated with one or more cash-based financial transactions for use in generating and/or modifying a user profile. Embodiments of the disclosure enable transaction data to be generated using a variety of data from various sources, thereby potentially increasing a robustness of a user profile generated using the transaction data. The user profile may be generated, for example, using location data associated with one or more user devices and transaction data associated with one or more members of a payment processing network. The embodiments described herein may analyze the location data to determine a user footprint of a cardholder, generate a merchant list including one or more merchants physically located in the user footprint, generate one or more parameters associated with the merchants, and use the parameters to generate transaction data associated with one or more cash-based financial transactions between the merchants and the user.

Aspects of the disclosure provide for a computing system that performs one or more operations in an environment including a plurality of devices coupled to each other via a network (e.g., a local area network (LAN), a wide area network (WAN), the Internet). For example, a financial transaction processing computing device may communicate with one or more user devices, merchant devices, and/or cash machines (e.g., automated teller machines (ATMs)) to generate transaction data. In some embodiments, the financial transaction processing computing device analyzes data associated with the user devices, merchant devices, and/or cash machines to have an enhanced understanding of a cardholder's interests, preferences, and/or tendencies, such that the financial transaction processing computing device is enabled to increase a robustness of a user profile associated with the cardholder.

The systems and processes described herein may be implemented using computer programming or engineering techniques including computer software, firmware, hardware or a combination or subset thereof. At least one technical problem with known computing systems is that it can be difficult, time-consuming, and/or onerous to obtain and/or generate data associated with one or more cash-based financial transactions. The embodiments described herein address at least this technical problem. By generating transaction data for generating and/or modifying a user profile in the manner described in this disclosure, some embodiments improve user experience, user efficiency, and/or user interaction performance by having a computing system that processes a variety of data from various sources without prompting the cardholder to provide additional input. Additionally, some embodiments improve processor security, data integrity, data transmission security, and/or communication between systems by using a central computing system to control communications and managing access to various accounts; improve cardholder confidence in financial institutions by using data that may be indicative of the purchasing tendencies of the cardholder; and/or reduce error rate by automating the processing of large volumes of data. Moreover, some embodiments may facilitate increasing processor speed and/or improving operating system resource allocation.

The technical effect of the systems and processes described herein is achieved by performing at least one of the following operations: a) determine whether a first user is enrolled in a program; b) receive identifier data associated with a user device of the first user; c) determine whether the user device is associated with the first user; d) receive location data associated with the user device; e) identify a first geolocation and a second geolocation associated with the location data; f) identify a third geolocation associated with the first geolocation and the second geolocation; g) identify one or more member locations associated with one or more members; h) determine a user footprint of the first user; i) identify one or more first members associated with the user footprint; j) compare a plurality of members associated with the user footprint with the first members; k) identify one or more second members associated with the user footprint; l) generate a member list; m) retrieve transaction data associated with one or more financial transactions between the second members and one or more second users different from the first user; n) identify a first transaction amount and a second transaction amount associated with the second members; o) determine a relationship between the first transaction amount and the second transaction amount; p) identify a withdrawal amount and a withdrawal time associated with the first user account; q) generate one or more parameters associated with the member list; r) generate transaction data associated with one or more financial transactions between the second members and the first user; and/or s) generate a user profile associated with the first user.

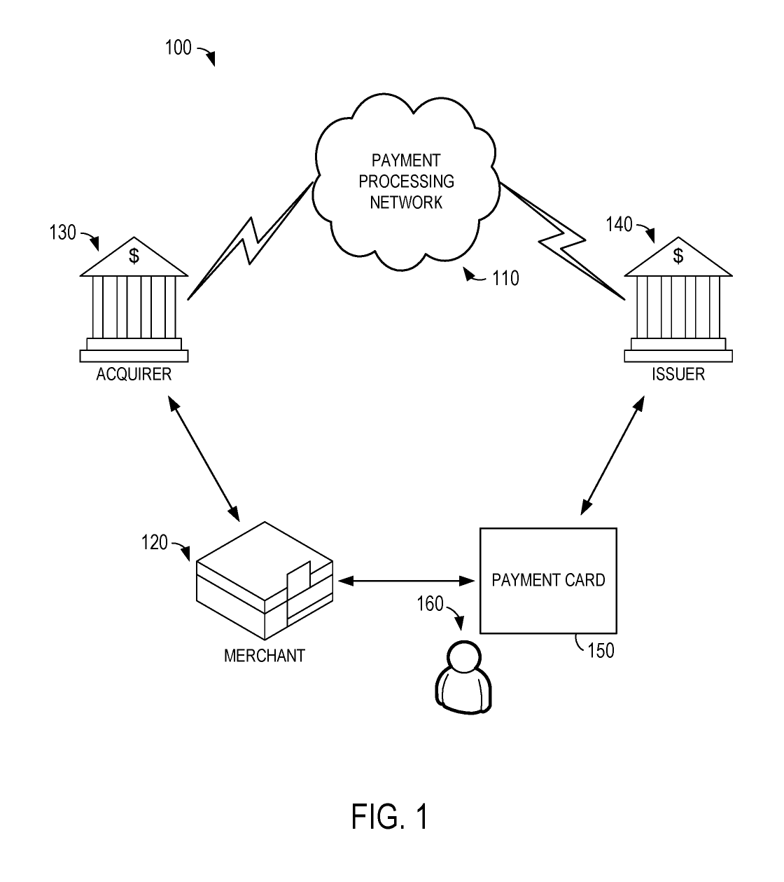

FIG. 1 is a block diagram illustrating an example environment 100 for processing one or more card-based financial transactions. The environment 100 includes a processing network 110, such as the MASTERCARD® brand payment processing network (MASTERCARD® is a registered trademark of MasterCard International Incorporated located in Purchase, N.Y.). The MASTERCARD® brand payment processing network is a propriety network for exchanging financial transaction data between members of the MASTERCARD® brand payment processing network.

The environment 100 includes one or more merchants 120 that accept payment via the processing network 110. To accept payment via the processing network 110, the merchant 120 establishes a financial account with an acquirer 130 that is a member of the processing network 110. The acquirer 130 is a financial institution that maintains a relationship with one or more merchants 120 to enable the merchants 120 to accept payment via the processing network 110. The acquirer 130 may also be known as an acquiring bank, a processing bank, or a merchant bank.

The environment 100 includes one or more issuers 140 that issue or provide one or more payment cards 150 to one or more cardholders 160 or, more broadly, account holders (“cardholder” and “account holder” may be used interchangeably herein). An issuer 140 is a financial institution that maintains a relationship with a cardholder 160 to enable the cardholder 160 to make a payment using a payment card 150 via the processing network 110. As described herein, the term “payment card” includes credit cards, debit cards, prepaid cards, key fobs, digital cards, smart cards, and any other payment product that is linked or associated with a corresponding cardholder account maintained by the issuer 140.

The cardholder 160 may use the payment card 150 to enter into one or more financial transactions with one or more merchants 120. The payment card 150 may have any shape, size, or configuration that enables the cardholder 160 to make a payment to a merchant 120 using a cardholder account. For example, account information stored in a microchip or magnetic stripe on the payment card 150 may be used to identify a cardholder account associated with the payment card 150. In some embodiments, the payment card 150 uses mobile payment technology and/or contactless payment technology to facilitate communication between the cardholder 160 and the merchant 120.

For example, the payment card 150 may include or be associated with a radio frequency identification (RFID)-enabled device, a BLUETOOTH® brand wireless technology-enabled device, a ZIGBEE® brand communication-enabled device, a WI-FI® brand local area wireless computing network-enabled device, and/or a near field communication (NFC) wireless communication-enabled device. (BLUETOOTH® is a registered trademark of Bluetooth Special Interest Group, ZIGBEE® is a registered trademark of the ZigBee Alliance, and WI-FI® is a registered trademark of the Wi-Fi Alliance).

In some embodiments, the cardholder 160 presents the merchant 120 with the payment card 150 to make a payment to the merchant 120 using the cardholder account in exchange for the good or service. Alternatively, the cardholder 160 may provide the merchant 120 with account information associated with the payment card 150 without physically presenting the payment card 150 to the merchant 120 (e.g., for remote financial transactions, including e-commerce transactions, card-not-present transactions, or card-on-file transactions). Account information may include, for example, a name of the cardholder 160, an account number, an expiration date, and/or a security code (e.g., a card verification value (CVV), a card verification code (CVC), a personal identification number (PIN)).

The merchant 120 requests authorization from an acquirer 130 for at least the amount of the purchase. The merchant 120 may request authorization using any financial transaction computing device configured to transmit account information of the cardholder 160 (e.g., account information obtained from the payment card 150) to one or more financial transaction processing computing devices of the acquirer 130. For example, the merchant 120 may use a point-of-sale (POS) terminal that reads account information from the microchip or magnetic stripe on the payment card 150 and transmits the account information to a financial transaction processing computing device of the acquirer 130. Additionally or alternatively, the POS terminal may receive the account information from a communication device using mobile payment technology and/or contactless payment technology, and transmit the account information to the financial transaction processing computing device of the acquirer 130.

Using the processing network 110, the financial transaction processing computing device of the acquirer 130 communicates with one or more financial transaction processing computing devices of an issuer 140 to determine whether the account information of the cardholder 160 matches or corresponds to the account information of the issuer 140 (e.g., account information registered with the issuer 140), whether the cardholder account is in good standing, and/or whether the purchase is covered by (e.g., a purchase amount is less than) an available credit line or account balance associated with the cardholder account. Based on these determinations, a financial transaction processing computing device of the issuer 140 determines whether to approve or decline the request for authorization from the merchant 120.

If the request for authorization is declined, the merchant 120 is notified (e.g., via the processing network 110) as such, and may request authorization from the acquirer 130 for a lesser amount or request an alternative form of payment (e.g., cash, another payment card 150) from the cardholder 160. If the request for authorization is approved, an authorization code is issued (e.g., via the processing network 110) to the merchant 120, and the available credit line or account balance associated with the cardholder account is decreased by at least the amount of the purchase. The financial transaction is then settled between the merchant 120, the acquirer 130, the issuer 140, and/or the cardholder 160. Settlement typically includes the acquirer 130 reimbursing the merchant 120 for selling the good or service, and the issuer 140 reimbursing the acquirer for reimbursing the merchant 120. When a credit card is used, the issuer 140 may bill the cardholder 160 to settle the cardholder account (e.g., a credit card account) with the cardholder 160. When a debit or prepaid card is used, the issuer 140 may automatically withdraw funds from the cardholder account (e.g., a checking account, a savings account) to settle the cardholder account.

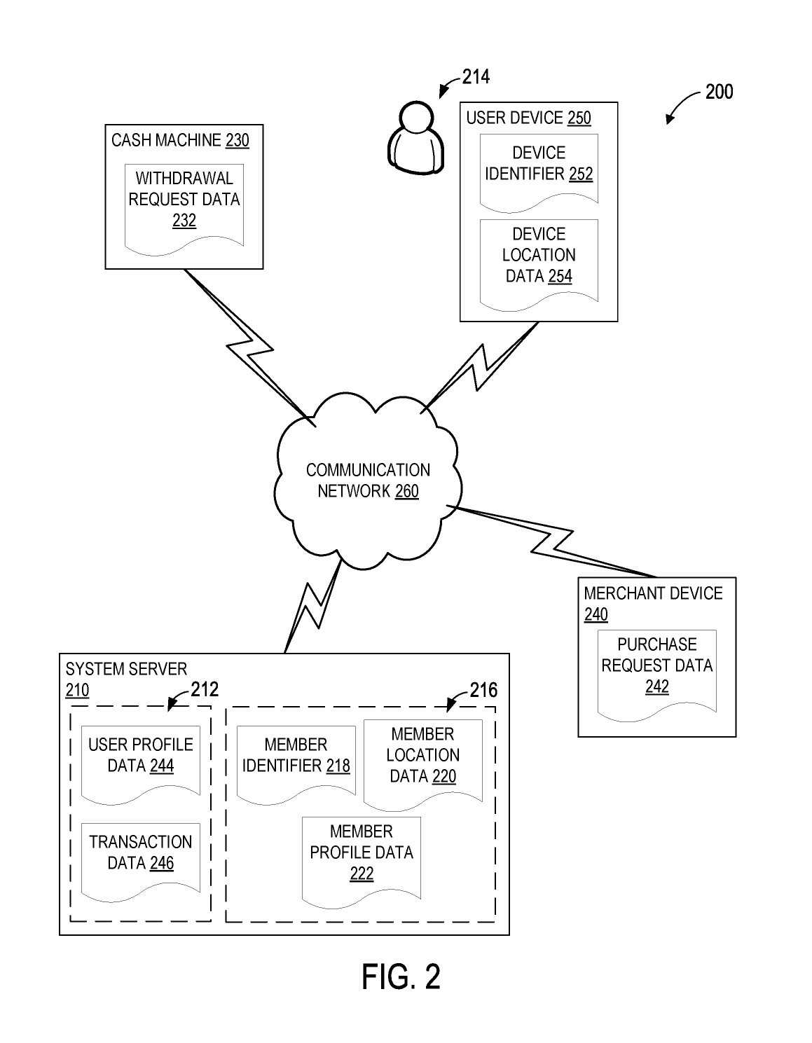

FIG. 2 is a block diagram illustrating an example environment 200 for processing one or more cash-based financial transactions. The environment 200 includes a system server 210 (e.g., a financial transaction processing computing device of an issuer 140) that maintains one or more user accounts 212 (e.g., a cardholder account) associated with one or more users 214 (e.g., a cardholder 160), and one or more member accounts 216 associated with one or more members of a processing network 110 (e.g., merchant 120).

A member account 216 may include, for example, member identifier 218, member location data 220, member profile data 222, and/or a member transaction history associated with one or more financial transactions between the member and one or more users (e.g., user 214). Member identifier 218 may include a member name, a member identifier, and/or any other information that enables a member associated with the member account 216 to be identified. Member location data 220 may include a street address, a postal code, a city, a geographic coordinate (e.g., latitude, longitude), and/or any other information that enables a real-world geographic location or geolocation of the member to be identified. Member profile data 222 may include a member industry, a member size, a revenue, and/or any other information that characterizes the member and/or enables a member interest, preference, and/or tendency to be identified.

In some embodiments, one or more cash machines 230 (e.g., an automated teller machine (ATM), a point-of-sale (POS) terminal) are members of the processing network 110. A cash machine 230 may enable a user 214, for example, to enter into one or more cash-based financial transactions. In some embodiments, the user 214 presents the cash machine 230 with a payment card 150 (shown in FIG. 1) for withdrawing or obtaining cash from the cash machine 230. Cash may be obtained, for example, through a cash withdrawal action that allows funds to be withdrawn from a user account 212 (e.g., a checking account, a savings account) and/or a cash disbursement action that allows cash to be “purchased” from the cash machine 230 using a user account 212 (e.g., a credit card account).

In some embodiments, the cash machine 230 communicates (e.g., via one or more processing networks 110) with the system server 210 to request authorization to dispense or provide cash to the user 214. For example, the cash machine 230 may obtain account information associated with the payment card 150 (e.g., name, account number, expiration date, security code), and use the account information to generate withdrawal request data 232 for requesting authorization from the system server 210. The cash machine 230 may transmit the withdrawal request data 232 to the system server 210, and the system server 210 may process the withdrawal request data 232 to generate a disposition of the request for authorization (e.g., approval or declination). Withdrawal request data 232 may include, for example, the account information and a withdrawal amount.

In some embodiments, the system server 210 determines the disposition based on whether the account information associated with the payment card 150 matches or corresponds to account information maintained at the system server 210 (e.g., registered account information), whether the user account 212 is in good standing, and/or whether the withdrawal amount is less than an account capacity associated with the user account 212 (e.g., account balance, available credit line). If the request for authorization is declined, the system server 210 transmits an instruction to withhold cash from (e.g., to not provide cash to) the user 214. On the other hand, if the request for authorization is approved, the system server 210 decreases the account capacity associated with the user account 212 by the withdrawal amount, and transmits an instruction to provide cash to the user 214. The financial transaction may then be settled between the cash machine 230, the user 214, and/or one or more members of the processing networks 110 (e.g., acquirer 130, issuer 140).

Cash (e.g., obtained from the cash machine 230) may be used to enter into one or more cash-based financial transactions with one or more merchants 120 (shown in FIG. 1). Additionally or alternatively, the user 214 may enter into one or more financial transactions with the merchants 120 using the payment card 150, as described above with respect to FIG. 1. A merchant 120 may use, for example, a merchant device 240 (e.g., a POS terminal) that obtains account information associated with the payment card 150, generates purchase request data 242 using the account information, and communicates (e.g., via the processing networks 110) with the system server 210 to request authorization to make a payment to the merchant 120. Purchase request data 242 may include, for example, the account information and a purchase amount.

The user account 212 includes user profile data 244 and/or a user transaction history. User profile data 244 may include an age, a gender, a marital status, a household size, a level of education, an occupation, an income, a credit score, a housing status, a hobby, and/or any other information that characterizes the member and/or enables a user interest, preference, and/or tendency to be identified. The user transaction history may include transaction data 246 associated with one or more financial transactions between one or more members (e.g., merchant 120, cash machine 230) and the user 214. At least some transaction data 246 may be generated, for example, based on withdrawal request data 232 and/or purchase request data 242. Transaction data 246 may include a member name, a member identifier, a member industry, a transaction identifier, a transaction description, a transaction time, a transaction amount (e.g., withdrawal amount, purchase amount), a transaction location (e.g., withdrawal geolocation, purchase geolocation), a transaction type (e.g., deposit, withdrawal, purchase, return), and/or any other information that is associated with a financial transaction.

In some embodiments, the user account 212 is linked or associated with one or more other user accounts associated with the user 214. The user account 212 may include, for example, data associated with one or more linked user accounts (e.g., contact data, credential data, profile data, transaction data). Linked user accounts may include, for example, credit card accounts, debit card accounts, prepaid card accounts, smart card accounts, resident accounts, employee accounts, membership accounts, and the like. In some embodiments, data associated with one or more linked user accounts may be used to generate and/or modify the user profile data 244 and/or transaction data 246.

The environment 200 includes a user device 250 that enables the user 214 to communicate with one or more other computing systems (e.g., system server 210, cash machine 230, merchant device 240). A device identifier 252 associated with the user device 250 may be registered and/or associated with the user account 212 to enable the system server 210 to associate the user device 250 with the user 214. Device identifiers 252 may include an identifier, a routing number, a media access controller (MAC) address, an Internet Protocol (IP) address, a telephone number, and/or any other information that enables a user device 250 to be identified.

The user device 250 may include one or more applications (“apps”) and an operating system that enables the user 214 to use the apps in a user-friendly manner. For example, the operating system may include one or more application program interfaces (APIs) that enable the user device 250 to present information to and/or obtain user input from the user 214 (e.g., via a graphical user interface) and/or to transmit data to and/or receive data from one or more other computing systems (e.g., via a network interface). A payment card app, for example, may allow the user 214 to use the user device 250 to communicate with the system server 210, the cash machine 230, and/or the merchant device 240 for entering into one or more financial transactions (e.g., using a payment card 150). For another example, a geolocation app may allow a geolocation of the user device 250 to be identified.

In some embodiments, the user device 250 generates device location data 254, and transmits the device location data 254 to one or more other computing systems (e.g., system server 210) to enable the other computing systems to identify one or more geolocations. For example, the user device 250 may include or be associated with a Global Positioning System (GPS) transceiver. Device location data 254 may include a street address, a postal code, a city, a geographic coordinate, and/or any other information that enables a geolocation of the user device 250 to be identified.

The environment 200 includes one or more communication networks 260 that enable data to be transferred between a plurality of computing systems coupled to the communication networks 260 (e.g., system server 210, cash machine 230, merchant device 240, user device 250). Example communication networks 260 include a cellular or mobile network and the Internet. Alternatively, the communication networks 260 may include any communication medium that enables the environment 200 to function as described herein including, for example, a personal area network (PAN), a LAN, and/or a WAN.

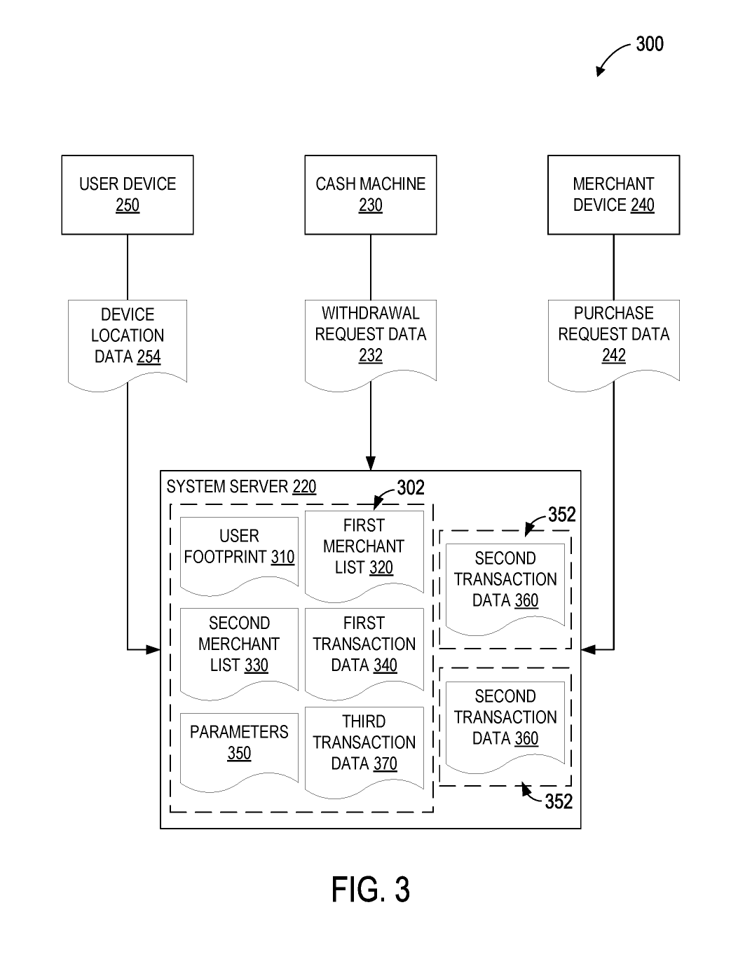

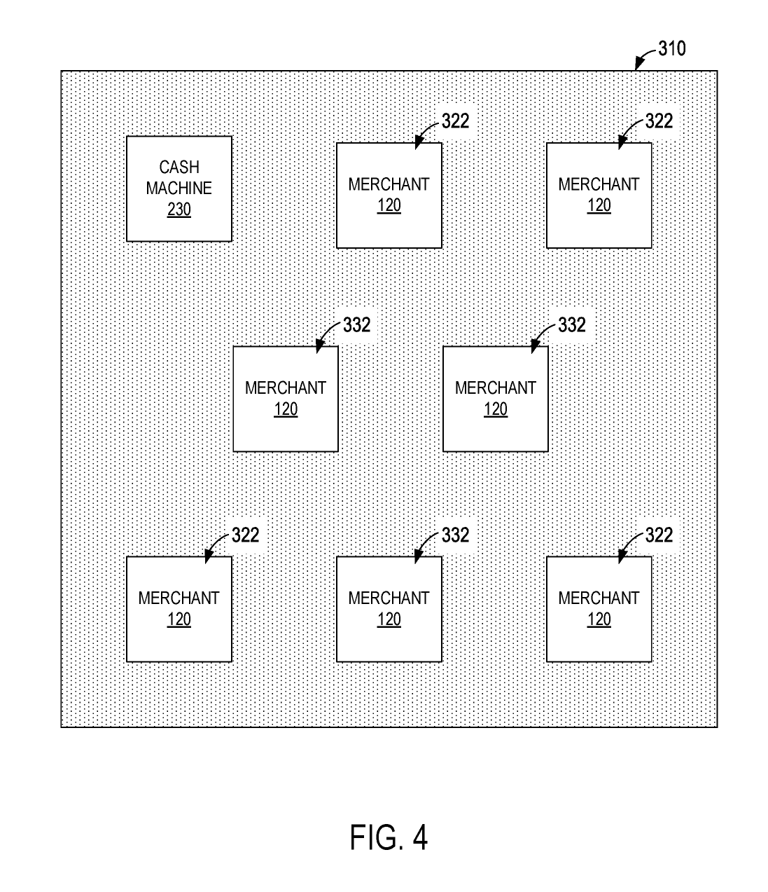

FIG. 3 is a block diagram illustrating an ecosystem 300 for generating transaction data 246 associated with one or more financial transactions for a first user account 302 (e.g., user account 212). FIG. 4 is block diagram illustrating a user footprint 310 that is representative of an area traversed by a first user (e.g., user 214) associated with the first user account 302 within a predetermined time period. The area may include, for example, one or more geolocations at which the first user entered into one or more financial transactions. In some embodiments, the system server 210 determines or generates the user footprint 310. The user footprint 310 may include one or more geolocations traversed by a user device 250 of the first user. The geolocations may be identified, for example, based on device location data 254 associated with the user device 250.

Additionally or alternatively, the user footprint 310 may include one or more geolocations at which one or more user accounts associated with the first user were used to enter into one or more card-based financial transactions. For example, the user footprint 310 may include one or more geolocations at which the first user account 302 was used to enter into one or more card-based financial transactions. The geolocations may be identified, for example, based on transaction data 246 associated with the first user account 302. In some embodiments, the system server 210 analyzes transaction data 246 to identify one or more cash machines 230 and/or merchant devices 240 at which a payment card 150 was presented, and analyze member location data 220 associated with the identified cash machines 230 and/or merchant devices 240 to identify one or more geolocations (e.g., withdrawal geolocation, purchase geolocation). The identified geolocations may be used to generate at least a portion of the user footprint 310.

In some embodiments, the system server 210 generates and/or modifies the user footprint 310 to include one or more geolocations proximate to, between, and/or associated with the geolocations identified based on device location data 254 and/or member location data 220. For example, the device location data 254 and/or member location data 220 may be analyzed to identify a first geolocation and a second geolocation, and the first geolocation and the second geolocation may be used to identify one or more third geolocations. The third geolocations may be located within one or more predetermined radii of the first geolocation and/or the second geolocation, between the first geolocation and the second geolocation, and/or at a locale (e.g., shopping mall, strip mall, commercial district) associated with the first geolocation and/or second geolocation.

The system server 210 is configured to generate a first merchant list 320 or first member list using the user footprint 310. The first merchant list 320 may be representative of one or more merchants 120 with whom the first user potentially entered into one or more cash-based financial transactions within the predetermined time period. The first merchant list 320 may be generated, for example, based on the merchants 120 physically located in the area. In some embodiments, the system server 210 compares the user footprint 310 with member location data 220 associated with one or more member accounts 216 to identify one or more merchants 120 physically located in the area represented by the user footprint 310.

In some embodiments, the system server 210 determines a likelihood of the first user entering into one or more cash-based financial transactions for each merchant 120 identified in the first merchant list 320. The likelihood may be determined, for example, based on first transaction data 340 associated with one or more first financial transactions between one or more merchants 120 and the first user (e.g., transaction data 246). The merchants 120 associated with one or more first financial transactions may be identified as first merchants 322 (shown in FIG. 4). In some embodiments, the system server 210 determines that it is less likely for the first user to enter into one or more cash-based financial transactions with a merchant 120 associated with one or more first financial transactions (e.g., when there are one or more card-based financial transactions with the merchant 120) than a merchant 120 that is not associated with a first financial transaction (e.g., when there are no card-based financial transactions with the merchant 120).

The first merchant list 320 may be modified to generate a second merchant list 330 or second member list that is representative of one or more merchants 120 with whom the first user likely entered into one or more cash-based financial transactions within the predetermined time period. In some embodiments, the system server 210 removes one or more merchants 120 with whom the first user is less likely to enter into one or more cash-based financial transactions (e.g., first merchants 322) from the merchants 120 identified in the first merchant list 320 to generate the second merchant list 330. One or more merchants 120 that are not associated with a first financial transaction, for example, may be identified in the second merchant list 330. The merchants 120 not associated with one or more first financial transactions may be identified as second merchants 332 (shown in FIG. 4). The second merchants 332 may be identified, for example, by removing one or more first merchants 322 from the merchants 120 identified in the first merchant list 320.

In some embodiments, one or more first merchants 322 may be added to the second merchant list 330 if, for example, the likelihood satisfies a predetermined threshold (e.g., a cash-based transaction between the merchant 120 and the first user is determined to be more likely). For example, user profile data 244, transaction data 246, and/or device location data 254 may be used to determine and/or modify the likelihood of the first user entering into one or more cash-based financial transactions. Conversely, one or more second merchants 332 may be removed from the second merchant list 330 if the likelihood does not satisfy the predetermined threshold (e.g., a cash-based transaction between the merchant 120 and the first user is determined to be less likely).

In some embodiments, the system server 210 analyzes user profile data 244, transaction data 246, and/or device location data 254 to identify one or more user interests, preferences, and/or tendencies of the first user. User profile data 244 and/or transaction data 246 may be compared with member profile data 222 associated with the merchant 120 to determine and/or modify the likelihood based on a relationship between the user data (e.g., user profile data 244, transaction data 246) and the merchant data (e.g., member profile data 222). If the user data is not aligned with the merchant data, it may be determined to be less likely for the first user to enter into one or more cash-based financial transactions with the merchant 120. On the other hand, if the user data is aligned with the merchant data, it may be determined to be more likely for the first user to enter into one or more cash-based financial transactions with the merchant 120.

Additionally or alternatively, device location data 254 may be analyzed to identify one or more geolocations at which a duration satisfies a predetermined temporal threshold (e.g., the user device 250 was physically located at a geolocation for at least the predetermined temporal threshold). The identified geolocations may be compared with member location data 220 associated with one or more member accounts 216 to identify one or more merchants 120 at which the user device 250 was physically located for at least the predetermined threshold. If the user device 250 was not physically located at the merchant 120 for at least the predetermined temporal threshold, it may be determined to be less likely for the first user to enter into one or more cash-based financial transactions with the merchant 120. On the other hand, if the user device 250 was physically located at the merchant 120 for at least the predetermined temporal threshold, it may be determined to be more likely for the first user to enter into one or more cash-based financial transactions with the merchant 120.

The system server 210 is configured to calculate or generate one or more parameters 350 for each merchant 120 identified in the second merchant list 330. The parameters 350 may be representative of a distribution of funds and/or transactions associated with the merchants 120 identified in the second merchant list 330. One or more second user accounts 352 associated with one or more second users, for example, may be used to generate the parameters 350 based on second transaction data 360 associated with one or more second financial transactions between the second merchants 332 and the second users. In some embodiments, the system server 210 analyzes the second transaction data 360 to identify one or more parameters 350 for each second merchant 332 (e.g., a first transaction amount) and one or more aggregate parameters 350 for the second merchants 332 identified in the second merchant list 330 (e.g., a second transaction amount). Parameters 350 may include, for example, a purchase amount per transaction, a purchase amount per product, a purchase amount per unit of time, a quantity of products per transaction, a quantity of products per unit of time, a quantity of transactions per unit of time, a proportional spend (e.g., a parameter associated with a merchant 120 divided by an aggregate parameter associated with one or more merchants 120 identified in the second merchant list 330), and/or any other information that quantifies a financial transaction.

User profile data 244, transaction data 246, and/or device location data 254 may be used to generate and/or modify the parameters 350. For example, user profile data 244, transaction data 246, and/or device location data 254 may be analyzed to identify one or more user interests, preferences, and/or tendencies of the first user. In some embodiments, the system server 210 compares user profile data 244 and/or transaction data 246 with member profile data 222 associated with the merchant 120 to determine and/or modify the likelihood based on a relationship between the user data (e.g., user profile data 244, transaction data 246) and the merchant data (e.g., member profile data 222). For example, if the user data is not aligned with the merchant data, the parameters 350 associated with the merchant 120 may be generated and/or modified to have a lesser weight or value. On the other hand, if the user data is aligned with the merchant data, the parameters 350 associated with the merchant 120 may be generated and/or modified to have a greater weight or value.

The system server 210 is configured to apply the parameters 350 to a withdrawal amount associated with the first user account 302 to generate third transaction data 370. The third transaction data 370 may be representative of one or more cash-based financial transactions between the second merchants 332 and the first user within the predetermined time period. In this manner, first transaction data 340 associated with the first user may be used to generate the second merchant list 330, and second transaction data 360 associated with one or more other second users may be used to estimate or determine third transaction data 370 associated with one or more cash-based financial transactions between the merchants 120 identified in the second merchant list 330 and the first user. In some embodiments, the system server 210 uses the third transaction data 370 to generate and/or modify a user profile associated with the first user.

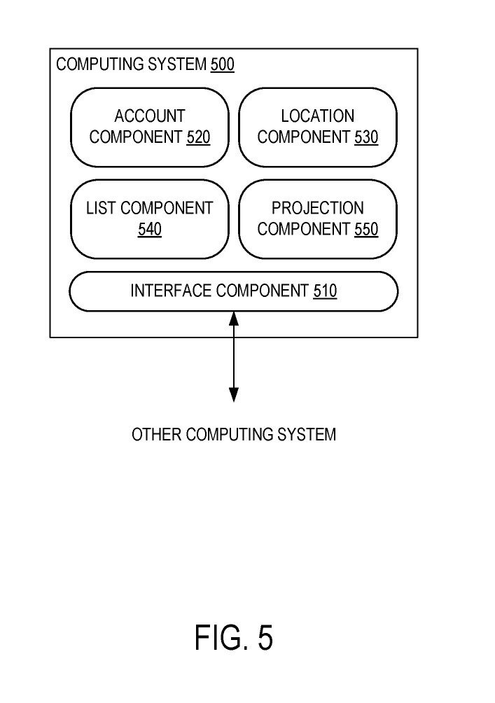

FIG. 5 is a block diagram illustrating a computing system 500 (e.g., a system server 210) including an interface component 510, an account component 520, a location component 530, a list component 540, and/or a projection component 550 that may be used to generate transaction data for one or more cash-based financial transactions. In some embodiments, the interface component 510 enables the computing system 500 to receive data from and/or transmit data to one or more other computing systems (e.g., cash machine 230, merchant device 240, user device 250). For example, the interface component 510 may be coupled to another computing system to facilitate communication between the other computing system and the location component 530, list component 540, projection component 550, and/or projection component 550. Additionally or alternatively, the interface component 510 may facilitate communication between and among the location component 530, list component 540, projection component 550, and/or projection component 550.

The account component 520 enables the computing system 500 to manage data associated with one or more accounts (e.g., user account 212, member account 216, first user account 302, second user account 352). Account data stored and maintained at the computing system 500 may include, for example, data registered with the computing system 500, such as credential data and/or contact data. Credential data includes any data that enables any entity (e.g., merchant 120, acquirer 130, issuer 140, cardholder 160, user 214) to be identified and/or authenticated, such as an identifier, an account number, a public key infrastructure (PKI) certificate, a password, a personal identification number (PIN), a token, and/or biometric data. For example, credential data may be used to selectively allow one or more users 214 to access and use account data associated with one or more user accounts 212. Contact data includes any data that enables any entity (e.g., system server 210, cash machine 230, merchant device 240, user device 250) to be located and/or approached for communicating with the entity, such as an identifier, a routing number, a media access controller (MAC) address, an Internet Protocol (IP) address, and/or a telephone number.

The account component 520 may use account data to communicate (e.g., via the interface component 510) with one or more other computing systems (e.g., cash machine 230, merchant device 240, user device 250, an account system associated with a linked user account) and obtain, from the other computing systems, data associated with one or more accounts. For example, account data may include credential data and/or contact data associated with a user account 212 for identifying or obtaining device location data 254 from a user device 250 associated with the user account 212. In some embodiments, the account component 520 processes one or more registration requests to register data with the computing system 500. For example, a user account 212 may be registered to enroll in a program that allows transaction data associated with one or more cash-based financial transactions (e.g., third transaction data 370) to be generated. For another example, device identifier 252 may be registered to associate a user device 250 with a user account 212. The account component 520 is configured to register data with the computing system 500 such that the interface component 510, account component 520, location component 530, list component 540, and/or projection component 550 may access and/or use the data in an efficient manner.

The location component 530 enables the computing system 500 to generate a user footprint 310 based on one or more locations traversed by a user 214. Device location data 254 associated with a user device 250 of the user 214, for example, may be used to at least partially generate the user footprint 310. The location component 530 may communicate (e.g., via the interface component 510) with a user device 250 to obtain device location data 254 from the user device 250. In some embodiments, upon receiving device location data 254 from a user device 250, the location component 530 compares device data associated with the user device 250 with registered device identifier 252 to identify a user account 212 associated with the user device 250. Additionally or alternatively, the location component 530 may use registered device identifier 252 to identify a user device 250 associated with the user account 212, and communicate with the user device 250 to retrieve device location data 254 from the identified user device 250.

At least a portion of the user footprint 310 may be generated using one or more geolocations at which the user 214 entered into one or more financial transactions. Transaction data 246 associated with the user account 212 (e.g., first transaction data 340), for example, may be used to identify one or more geolocations at which the user 214 presented a payment card 150 to enter into one or more financial transactions. In some embodiments, the location component 530 analyzes the transaction data 246 to identify one or more cash machines 230 and/or merchant devices 240 at which the user 214 presented the payment card 150, and analyzes member location data 220 associated with the identified cash machines 230 and/or merchant devices 240 to identify the geolocations.

In some embodiments, the location component 530 communicates (e.g., via the interface component 510) with one or more other computing systems to identify one or more geolocations traversed by the user 214. For example, the other computing systems may generate and/or maintain location data for an account associated with the user 214, such as a resident account, an employee account, a membership account, and the like.

The list component 540 enables the computing system 500 to identify one or more merchants 120 potentially associated with one or more cash-based financial transactions. For example, the list component 540 may identify one or more merchants 120 physically located in the area represented by the user footprint 310 to generate a first merchant list 320. In some embodiments, the list component 540 uses data generated and/or maintained at the computing system 500 to identify one or more merchants 120 associated with member location data 220 that matches or corresponds to the user footprint 310. For example, member location data 220 associated with one or more member accounts 216 may match or correspond to the user footprint 310. For another example, transaction data 246 associated with the user account 212 (e.g., first transaction data 340) may be analyzed to identify one or more merchants 120 physically located in the area represented by the user footprint 310. Additionally or alternatively, the list component 540 may communicate (e.g., via the interface component 510) with one or more other computing systems to identify one or more merchants 120 physically located in the area represented by the user footprint 310. Location data associated with one or more merchants 120 may be obtained, for example, from a map system, a directory system, a customer review system, and the like.

In some embodiments, the list component 540 generates one or more confidence scores that indicate one or more likelihoods of the user 214 entering into one or more cash-based financial transactions with the identified merchants 120. Purchase request data 242, for example, may be used to generate one or more confidence scores. If a merchant 120 is associated with first transaction data 340 (e.g., the merchant 120 is a first merchant 322), the list component 540 may generate a confidence score that indicates that it is unlikely for the user 214 to enter into one or more cash-based financial transactions with the merchant 120. Conversely, if a merchant 120 is not associated with first transaction data 340 (e.g., the merchant 120 is a second merchant 332), the list component 540 may generate a confidence score that indicates that it is likely for the user 214 to enter into one or more cash-based financial transactions with the merchant 120. Additionally or alternatively, user profile data 244, transaction data 246, and/or device location data 254 may be used to generate one or more confidence scores. For example, the list component 540 may analyze user profile data 244, transaction data 246, and/or device location data 254 to identify one or more user interests, preferences, and/or tendencies, and compare the user interests, preferences, and/or tendencies with member profile data 222 associated with the merchants 120 to generate the confidence scores.

The list component 540 may use the confidence scores, for example, to determine whether the merchants 120 are included in a second merchant list 330. The second merchant list 330 may identify one or more merchants 120 with whom the user 214 is determined to enter into one or more cash-based financial transactions. For example, the list component 540 may generate the second merchant list 330 to include a merchant 120 if the confidence scores indicate that a cash-based financial transaction with the merchant 120 is likely, and to exclude the merchant 120 if the confidence scores indicate that the cash-based financial transaction with the merchant 120 is not likely. In some embodiments, the list component 540 calculates or generates one or more weights for adjusting one or more confidence scores. The weights may indicate, for example, a reliability of or a confidence in the confidence scores.

The projection component 550 enables the computing system 500 to generate third transaction data 370 associated with one or more cash-based financial transactions between the merchants 120 identified in the second merchant list 330 and the user 214. The projection component 550 may determine, for example, one or more parameters 350 that set or define one or more boundaries for generating the third transaction data 370. The parameters 350 may be determined based on data associated with one or more users other than the user 214 (e.g., second users). In some embodiments, the projection component 550 uses second transaction data 360 associated with one or more financial transactions between the merchants 120 identified in the second merchant list 330 and the second users to determine the parameters 350. Additionally or alternatively, the parameters 350 may be determined based on data associated with the user 214. For example, one or more parameters 350 may be modified based on user profile data 244, transaction data 246, and/or device location data 254.

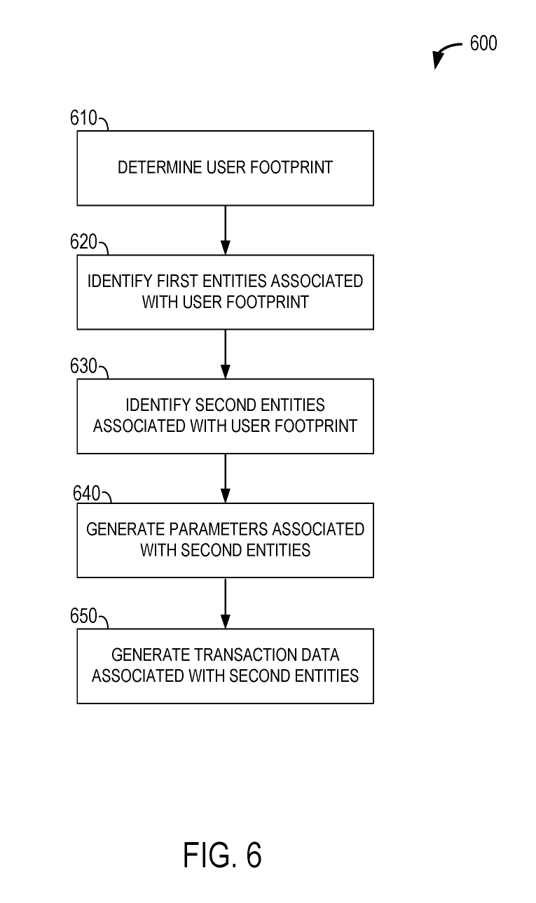

FIG. 6 is a flowchart of an example method 600 for generating transaction data for one or more cash-based financial transactions using a computing system 500 (shown in FIG. 5). Third transaction data 370, for example, may be generated for one or more cash-based financial transactions entered into using cash obtained at one or more cash machines 230 (e.g., via a cash withdrawal action or cash disbursement action). In some embodiments, the computing system 500 generates third transaction data 370 associated with a user 214 (e.g., a first user) on condition that a user account 212 associated with the user 214 (e.g., first user account 302) is enrolled in a program that allows the third transaction data 370 to be generated. The user account 212 may be enrolled in the program, for example, on condition that a frequency of financial transactions having a first transaction type (e.g., withdrawal) satisfies a predetermined threshold. Additionally or alternatively, the user 214 may enroll the user account 212 in the program.

First transaction data 340 associated with the user account 212 is analyzed to identify a transaction amount (e.g., a withdrawal amount) of a first financial transaction having a first transaction type (e.g., withdrawal) and determine a time period associated with the first financial transaction (e.g., a withdrawal time). For example, the computing system 500 may identify that $100 in cash was withdrawn from a cash machine 230, and determine the time period by identifying a difference between a first transaction time of the first financial transaction and a second transaction time of a second financial transaction having the first transaction type (e.g., a subsequent withdrawal). Additionally or alternatively, the time period may be determined and/or modified by analyzing user profile data 244, transaction data 246, and/or device location data 254 to determine a transaction rate (e.g., a purchase amount per transaction, a purchase amount per unit of time, a quantity of transactions per unit of time), and comparing the transaction amount with the transaction rate. In some embodiments, the computing system 500 uses data associated with one or more linked user accounts to identify the withdrawal amount and/or determine withdrawal time.

One or more locations traversed by the user 214 during the time period are identified to generate at 610 a user footprint 310 including location data associated with the identified locations. The location data may include, for example, device location data 254 received from a user device 250 associated with the user account 212. Additionally or alternatively, location data may be obtained from the user account 212 and/or one or more member accounts 216 maintained at the computing system 500. The user account 212 and/or member accounts 216 may include, for example, transaction data (e.g., transaction data 246, first transaction data 340) that may be used to identify one or more locations traversed by the user 214 within the time period. In some embodiments, the computing system 500 uses data associated with one or more linked user accounts to generate and/or modify the user footprint 310.

One or more merchants 120 physically located in the area represented by the user footprint 310 are identified for generating a first merchant list 320. Identified merchants 120 may include one or more first merchants 322 who entered into one or more financial transactions with the user 214 during the time period and/or one or more second merchants 332 who did not enter into one or more financial transactions with the user 214 during the time period. The first merchants 322 may be identified at 620, for example, by analyzing first transaction data 340 associated with the user account 212. In some embodiments, one or more first merchants 322 are identified and removed from the first merchant list 320 to identify at 630 one or more second merchants 332 different from the first merchants 322 for generating a second merchant list 330.

For example, the computing system 500 may identify that a grocery store, a coffee shop, and a hobby store are physically located in the area represented by the user footprint 310. If first transaction data 340 associated with the user account 212 indicates that a payment card 150 was presented to enter into a financial transaction with the grocery store and not with the coffee shop or the hobby store, the grocery store may be identified as a first merchant 322 and/or the coffee shop and the hobby store may be identified as second merchants 332. In some embodiments, the computing system 500 uses data associated with one or more linked user accounts to generate and/or modify the first merchant list 320 and/or second merchant list 330.

Transaction data associated with one or more other user accounts 212 (e.g., second transaction data 360 associated with one or more second user accounts 352) are analyzed to generate at 640 one or more parameters 350 associated with the merchants 120 identified in the second merchant list 330 (e.g., second merchants 332). The parameters 350 are used to generate at 650 third transaction data 370 associated with one or more cash-based financial transactions associated with the user 214. In this manner, the computing system 500 may use transaction data associated with one or more other users to project one or more cash-based financial transactions between the second merchants 332 and the user 214.

For example, the computing system 500 may determine that the $100 withdrawn from the cash machine 230 was spent at the coffee shop and the hobby store during the time period (i.e., the second merchant list 330 identifies the coffee shop and the hobby store). If one or more parameters 350 indicate that an average purchase amount associated with the coffee shop is $10, an average purchase amount associated with the hobby store is $40, the computing system 500 may determine that an aggregate purchase amount associated with the second merchant list 330 is $50. The computing system 500 may then divide the respective average purchase amounts by the aggregate purchase amount to determine that a proportional spend associated with the coffee shop is 20% and that a proportional spend associated with the hobby store is 80%. In this manner, the parameters 350 may be applied to the $100 withdrawn from the cash machine 230 to project that $20 in cash (i.e., 20%*$100) was spent at the coffee shop and $80 in cash (i.e., 80%*$100) was spent at the hobby store. In some embodiments, the computing system 500 uses data associated with one or more linked user accounts to generate and/or modify the parameters 350.

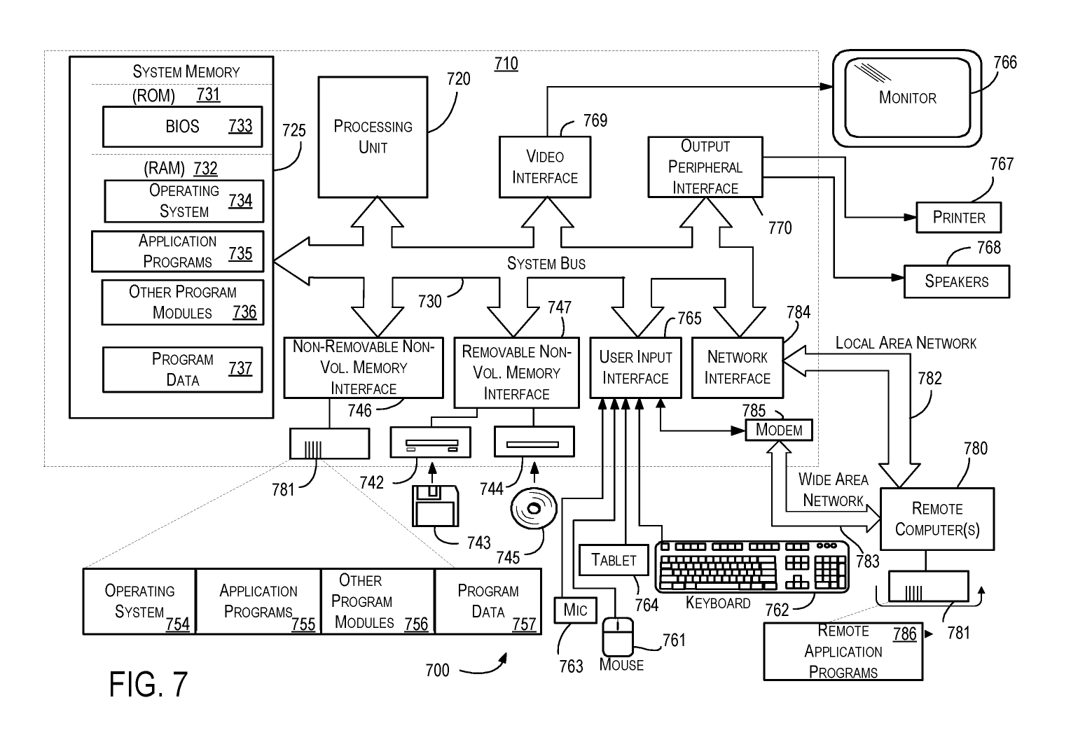

FIG. 7 is a block diagram illustrating an example operating environment 700 that may be used to generate transaction data for one or more cash-based financial transactions. The operating environment 700 is only one example of a computing and networking environment and is not intended to suggest any limitation as to the scope of use or functionality of the disclosure. The operating environment 700 should not be interpreted as having any dependency or requirement relating to any one or combination of components illustrated in the example operating environment 700.

The disclosure is operational with numerous other computing and networking environments or configurations. While some examples of the disclosure are illustrated and described herein with reference to the operating environment 700 being or including a system server 210 (shown, e.g., in FIG. 2) and/or a computing system 500 (shown in FIG. 5), aspects of the disclosure are operable with any computing device (e.g., cash machine 230, merchant device 240, user device 250) that executes instructions to implement the operations and functionality associated with the operating environment 700.

For example, the operating environment 700 may include a mobile device, a smart watch or device, a mobile telephone, a phablet, a tablet, a portable media player, a netbook, a laptop, a desktop computer, a personal computer, a server computer, a computing pad, a kiosk, a tabletop device, an industrial control device, a multiprocessor system, a microprocessor-based system, a set top box, programmable consumer electronics, a network computer, a minicomputer, a mainframe computer, a distributed computing environment that include any of the above systems or devices, and the like. The operating environment 700 may represent a group of processing units or other computing devices. Additionally, any computing device described herein may be configured to perform any operation described herein including one or more operations described herein as being performed by another computing device.

With reference to FIG. 7, an example system for implementing various aspects of the disclosure may include a general purpose computing device in the form of a computer 710. Components of the computer 710 may include, but are not limited to, a processing unit 720 (e.g., a processor), a system memory 725 (e.g., a computer-readable storage device), and a system bus 730 that couples various system components including the system memory 725 to the processing unit 720. The system bus 730 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The system memory 725 includes any quantity of media associated with or accessible by the processing unit 720. For example, the system memory 725 may include computer storage media in the form of volatile and/or nonvolatile memory, such as read only memory (ROM) 731 and random access memory (RAM) 732. The ROM 731 may store a basic input/output system 733 (BIOS) that facilitates transferring information between elements within computer 710, such as during start-up. The RAM 732 may contain data and/or program modules that are immediately accessible to and/or presently being operated on by processing unit 720. For example, the system memory 725 may store computer-executable instructions, application data, profile data (e.g., member profile data 222, user profile data 244), transaction data (e.g., withdrawal request data 232, purchase request data 242, transaction data 246, first transaction data 340, second transaction data 360, third transaction data 370), identifier data (e.g., member identifier 218, device identifier 252), location data (e.g., member location data 220, device location data 254), credential data, contact data, product data, temporal data, and other data.

The processing unit 720 may be programmed to execute the computer-executable instructions for implementing aspects of the disclosure, such as those illustrated in the figures (e.g., FIG. 6). For example, the system memory 725 may include an interface component 510 (shown in FIG. 5), an account component 520 (shown in FIG. 5), a location component 530 (shown in FIG. 5), a list component 540 (shown in FIG. 5), and/or a projection component 550 (shown in FIG. 5) for implementing aspects of the disclosure. The processing unit 720 includes any quantity of processing units, and the instructions may be performed by the processing unit 720 or by multiple processors within the operating environment 700 or performed by a processor external to the operating environment 700. By way of example, and not limitation, FIG. 7 illustrates operating system 734, application programs 735, other program modules 736, and program data 737.

Upon programming or execution of these components, the operating environment 700 and/or processing unit 720 is transformed into a special purpose microprocessor or machine. For example, the location component 530, when executed by the processing unit 720, causes the computer 710 to analyze device location data 254 to determine a user footprint 310; the list component 540, when executed by the processing unit 720, causes the computer 710 to analyze first transaction data 340 to identify one or more first merchants 322, and identify one or more second merchants 332 different from the first merchants 322 to generate a merchant list; and the projection component 550, when executed by the processing unit 720, causes the computer 710 to analyze second transaction data 360 to generate one or more parameters 350, and use the parameters 350 to generate third transaction data 370. Although the processing unit 720 is shown separate from the system memory 725, embodiments of the disclosure contemplate that the system memory 725 may be onboard the processing unit 720 such as in some embedded systems.

The computer 710 includes a variety of computer-readable media. Computer-readable media may be any available media that may be accessed by the computer 710 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. ROM 731 and RAM 732 are examples of computer storage media. Computer storage media are tangible and mutually exclusive to communication media. Computer storage media for purposes of this disclosure are not signals per se. Example computer storage media includes, but is not limited to, hard disks, flash drives, solid state memory, RAM, ROM, electrically erasable programmable read-only memory (EEPROM), flash memory or other memory technology, CDs, DVDs, or other optical disk storage, magnetic cassettes, magnetic tape, magnetic disk storage or other magnetic storage devices, or any other medium which may be used to store the desired information and which may accessed by the computer 710. Computer storage media are implemented in hardware and exclude carrier waves and propagated signals. Any such computer storage media may be part of computer 710.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

A user (e.g., user 214) may enter commands and information into the computer 710 through one or more input devices, such as a pointing device 761 (e.g., mouse, trackball, touch pad), a keyboard 762, a microphone 763, and/or an electronic digitizer 764 (e.g., tablet). Other input devices not shown in FIG. 7 may include a joystick, a game pad, a controller, a satellite dish, a camera, a scanner, an accelerometer, or the like. These and other input devices may be coupled to the processing unit 720 through a user input interface 765 that is coupled to the system bus 730, but may be connected by other interface and bus structures, such as a parallel port, game port or a universal serial bus (USB).

By way of example only, FIG. 7 illustrates a hard disk drive 741 that reads from or writes to non-removable, nonvolatile magnetic media, a magnetic disk drive 742 that reads from or writes to a removable, nonvolatile magnetic disk 743 (e.g., a floppy disk, a tape cassette), and an optical disk drive 744 that reads from or writes to a removable, nonvolatile optical disk 745 (e.g., a compact disc (CD), a digital versatile disc (DVD)). Other removable/non-removable, volatile/nonvolatile computer storage media that may be used in the example operating environment include, but are not limited to, flash memory cards, digital video tape, solid state RAM, solid state ROM, and the like. The hard disk drive 741 may be connected to the system bus 730 through a non-removable memory interface such as interface 746, and magnetic disk drive 742 and optical disk drive 744 may be connected to the system bus 730 by a removable memory interface, such as interface 747.

The drives and their associated computer storage media, described above and illustrated in FIG. 7, provide storage of computer-readable instructions, data structures, program modules and other data for the computer 710. In FIG. 7, for example, hard disk drive 741 is illustrated as storing operating system 754, application programs 755, other program modules 756 and program data 757. Note that these components may either be the same as or different from operating system 734, application programs 735, other program modules 736, and program data 737. Operating system 754, application programs 755, other program modules 756, and program data 757 are given different numbers herein to illustrate that, at a minimum, they are different copies.

Information, such as text, images, audio, video, graphics, alerts, and the like, may be presented to a user via one or more presentation devices, such as a monitor 766, a printer 767, and/or a speaker 768. Other presentation devices not shown in FIG. 7 may include a projector, a vibrating component, or the like. These and other presentation devices may be coupled to the processing unit 720 through a video interface 769 (e.g., for a monitor 766 or a projector) and/or an output peripheral interface 770 (e.g., for a printer 767, a speaker 768, and/or a vibration component) that are coupled to the system bus 730, but may be connected by other interface and bus structures, such as a parallel port, game port or a USB. In some embodiments, the presentation device is integrated with an input device configured to receive information from the user (e.g., a capacitive touch-screen panel, a controller including a vibrating component). Note that the monitor 766 and/or touch screen panel may be physically coupled to a housing in which the computer 710 is incorporated, such as in a tablet-type personal computer.

The computer 710 may operate in a networked environment using logical connections to one or more remote computers, such as a remote computer 780. The remote computer 780 may be a personal computer, a server, a router, a network PC, a peer device or other common network node, and typically includes many or all of the elements described above relative to the computer 710, although only a memory storage device 781 has been illustrated in FIG. 7. The logical connections depicted in FIG. 7 include one or more local area networks (LAN) 782 and one or more wide area networks (WAN) 783, but may also include other networks. Such networking environments are commonplace in offices, enterprise-wide computer networks, intranets and the Internet.

When used in a LAN networking environment, the computer 710 is coupled to the LAN 782 through a network interface or adapter 784. When used in a WAN networking environment, the computer 710 may include a modem 785 or other means for establishing communications over the WAN 783, such as the Internet. The modem 785, which may be internal or external, may be connected to the system bus 730 via the user input interface 765 or other appropriate mechanism. A wireless networking component including an interface and antenna may be coupled through a device, such as an access point or peer computer to a LAN 782 or WAN 783. In a networked environment, program modules depicted relative to the computer 710, or portions thereof, may be stored in the remote memory storage device. By way of example, and not limitation, FIG. 7 illustrates remote application programs 786 as residing on memory storage device 781. It may be appreciated that the network connections shown are examples and other means of establishing a communications link between the computers may be used.

The block diagram of FIG. 7 is merely illustrative of an example system that may be used in connection with one or more examples of the disclosure and is not intended to be limiting in any way. Further, peripherals or components of the computing devices known in the art are not shown, but are operable with aspects of the disclosure. At least a portion of the functionality of the various elements in FIG. 7 may be performed by other elements in FIG. 7, or an entity (e.g., processor, web service, server, applications, computing device, etc.) not shown in FIG. 7.

Although described in connection with an example computing system environment, embodiments of the disclosure are capable of implementation with numerous other general purpose or special purpose computing system environments, configurations, or devices. Embodiments of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, earphones, and the like), network PCs, minicomputers, mainframe computers, distributed computing environments that include any of the above systems or devices, and the like. Such systems or devices may accept input from the user in any way, including from input devices such as a keyboard or pointing device, via gesture input, proximity input (such as by hovering), and/or via voice input.

Embodiments of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other embodiments of the disclosure may include different computer-executable instructions or components having more or less functionality than illustrated and described herein.

The embodiments illustrated and described herein as well as embodiments not specifically described herein but within the scope of aspects of the disclosure constitute example means for generating transaction data for one or more cash-based financial transactions. For example, the elements illustrated in FIGS. 1-3, 5, and 7, such as when encoded to perform the operations illustrated in FIG. 6, constitute at least an example means for determining a user footprint 310 (e.g., location component 530); an example means for identifying one or more first merchants 322 associated with the user footprint 310 (e.g., list component 540); an example means for identifying one or more second merchants 332 associated with the user footprint 310 to generate a merchant list (e.g., list component 540); an example means for generating one or more parameters 350 associated with the second merchants 332 (e.g., projection component 550); and generating third transaction data 370 associated with one or more cash-based financial transactions between the second merchants 332 and the user 214 (e.g., projection component 550).

The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the embodiments thereof, the articles “a,” “an,” “the,” and “said” are intended to mean that there are one or more of the elements. Furthermore, references to an “embodiment” or “example” of the present disclosure are not intended to be interpreted as excluding the existence of additional embodiments or examples that also incorporate the recited features. The terms “comprising,” “including,” and “having” are intended to be inclusive and mean that there may be additional elements other than the listed elements. The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

In some embodiments, the operations illustrated in the drawings may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

While the aspects of the disclosure have been described in terms of various embodiments with their associated operations, a person skilled in the art would appreciate that a combination of operations from any number of different embodiments is also within scope of the aspects of the disclosure.

What is claimed is:

1. A computing system for generating transaction data associated with one or more financial transactions, the computing system comprising:
a memory device storing data associated with a plurality of user accounts and computer-executable instructions, the plurality of user accounts including a first user account associated with a first user and one or more second user accounts associated with one or more second users; and
a processor configured to execute the computer-executable instructions to:
analyze location data associated with a user device to determine a user footprint, the user device associated with the first user account;
analyze first transaction data associated with the first user account to identify one or more first members associated with the user footprint, the first transaction data associated with one or more first financial transactions between the one or more first members and the first user;
identify one or more second members associated with the user footprint to generate a member list, the one or more second members different from the one or more first members;
analyze second transaction data associated with the one or more second user accounts to generate one or more parameters associated with the member list, the second transaction data associated with one or more second financial transactions between the one or more second members and the one or more second users; and
use the one or more parameters to generate third transaction data for use in generating a user profile associated with the first user account, the third transaction data associated with one or more third financial transactions between the one or more second members and the first user.

2. The computing system of claim 1, wherein the processor is further configured to execute the computer-executable instructions to:
receive identifier data associated with the user device; and
based on the identifier data, determine whether the user device is associated with the first user account.

3. The computing system of claim 1, wherein the processor is further configured to execute the computer-executable instructions to:
determine whether a withdrawal rate associated with the first user account satisfies a predetermined threshold; and
on condition that the withdrawal rate satisfies the predetermined threshold, obtain the location data for monitoring the first user.

4. The computing system of claim 1, wherein the processor is further configured to execute the computer-executable instructions to analyze the location data to identify a first geolocation and a second geolocation, wherein the user footprint is determined to include a third geolocation between the first geolocation and the second geolocation.

5. The computing system of claim 1, wherein the processor is further configured to execute the computer-executable instructions to identify one or more member locations associated with the one or more first members, wherein the user footprint is determined to include the one or more member locations.

6. The computing system of claim 1, wherein the processor is further configured to execute the computer-executable instructions to compare a plurality of members associated with the user footprint with the one or more first members to identify the one or more second members.

7. The computing system of claim 1, wherein the processor is further configured to execute the computer-executable instructions to analyze the first transaction data to identify at least one second member of the one or more second members.

8. The computing system of claim 1, wherein the processor is further configured to execute the computer-executable instructions to analyze the second transaction data to identify at least one second member of the one or more second members.

9. The computing system of claim 1, wherein the processor is further configured to execute the computer-executable instructions to analyze the second transaction data to identify a first transaction amount and a second transaction amount associated with the one or more second members, wherein at least a portion of the one or more parameters is generated based on the first transaction amount and the second transaction amount.

10. The computing system of claim 1, wherein the processor is further configured to execute the computer-executable instructions to identify a withdrawal amount and a withdrawal time associated with the first user account, wherein the third transaction data is generated based on the withdrawal amount and the withdrawal time.

11. One or more computer storage media embodied with computer-executable instructions, the one or more computer storage media comprising:
a location component that, upon execution by at least one processor, causes a computing system associated with the at least one processor to obtain location data associated with a user device of a first user, and determine a user footprint based on the location data;
a list component that, upon execution by at least one processor, causes the computing system associated with the at least one processor to identify a plurality of merchants associated with the user footprint, obtain first transaction data associated with one or more first financial transactions between one or more first merchants of the plurality of merchants and the first user, identify one or more second merchants of the plurality of merchants different from the one or more first merchants, and generate a merchant list based on the one or more second merchants; and
a projection component that, upon execution by at least one processor, causes the computing system associated with the at least one processor to obtain second transaction data associated with one or more second financial transactions between the one or more second merchants and one or more second users different from the first user, generate one or more parameters associated with the merchant list based on the second transaction data, and generate third transaction data associated with one or more third financial transactions between the one or more second merchants and the first user based on the one or more parameters for use in generating a user profile associated with the first user.

12. The one or more computer storage media of claim 11, wherein the location component is configured to:
obtain identifier data associated with the user device; and
determine whether the user device is associated with the first user based on the identifier data.

13. The one or more computer storage media of claim 11, wherein the location component is configured to determine whether the first user is enrolled in a program, wherein the location data is obtained on condition that the first user is enrolled in the program.

14. The one or more computer storage media of claim 11, wherein the location component is configured to:
identify a first geolocation and a second geolocation based on the location data, wherein the user footprint is determined to include a third geolocation between the first geolocation and the second geolocation.

15. The one or more computer storage media of claim 11, wherein the location component is configured to:
identify one or more of one or more merchant locations associated with the one or more first merchants, wherein the user footprint is determined to include the one or more merchant locations.

16. The one or more computer storage media of claim 11, wherein the projection component is configured to identify a first purchase amount and a second purchase amount associated with the one or more second merchants based on the second transaction data, wherein at least a portion of the one or more parameters are generated based on the first purchase amount and the second purchase amount.

17. The one or more computer storage media of claim 11, wherein the projection component is configured to identify a withdrawal amount and a withdrawal time associated with the first user, wherein the third transaction data is generated based on the withdrawal amount and the withdrawal time.

18. A computer-implemented method for generating transaction data associated with one or more financial transactions, the computer-implemented method comprising:
analyzing location data associated with a user device of a first user to determine a user footprint;
analyzing first transaction data associated with the first user to identify one or more first merchants associated with the user footprint;
identifying one or more second merchants associated with the user footprint to generate a merchant list, the one or more second merchants different from the one or more first merchants;
analyzing second transaction data associated with one or more second users different from the first user to generate one or more parameters associated with the merchant list; and
using the one or more parameters to generate third transaction data associated with one or more cash-based financial transactions between the one or more second merchants and the first user for use in generating a user profile associated with the first user.

19. The computer-implemented method of claim 18 further comprising analyzing the location data to identify a first geolocation and a second geolocation, wherein the user footprint is determined to include a third geolocation between the first geolocation and the second geolocation.

20. The computer-implemented method of claim 18 further comprising:
analyzing the second transaction data to identify a first purchase amount and a second purchase amount associated with the one or more second merchants;
comparing the first transaction amount with the second transaction amount to determine a relationship between the first transaction amount and the second transaction amount, wherein at least a portion of the one or more parameters is generated based on the relationship; and
identifying a withdrawal amount and a withdrawal time associated with the first user, wherein the withdrawal amount and the withdrawal time are used to generate the third transaction data.
